(19) United States
(12) Patent Application Publication
(10) Pub. No.: US 2009/0230187 A1
(43) Pub. Date: Sep. 17, 2009

(54) CASH REGISTER SYSTEM AND METHOD OF OPERATING A CASH REGISTER SYSTEM

(75) Inventors: Dirk Leonard Benschop, Etten-Leur (NL); Henderik Reinout Benschop, Rozenburg (NL); Sander Ewout Sciarone, Fijnaart (NL)

Correspondence Address: WESTMAN CHAMPLIN & KELLY, P.A., SUITE 1400, 900 SECOND AVENUE SOUTH, MINNEAPOLIS, MN, 55402, US

(73) Assignee: Hollandse Exploitatie Maatschappij B.V., Etten-Leur (NL)

(21) Appl. No.: 12/348,491

(22) Filed: Jan. 5, 2009

Related U.S. Application Data
(63) Continuation-in-part of application No. 12/046,031, filed on Mar. 11, 2008.
Application No. 12/046,031 is a continuation of application No. PCT/NL2008/050858, filed on Dec. 30, 2008.

(51) Int. Cl. G06K 5/00

(52) U.S. Cl. 235/382

(57) ABSTRACT

Aspects of the invention relate to a cash register system and a method of operating a cash register system. The cash register system comprises an age verification system. An image of a person is captured and transmitted to a remote age verification center. An authorization signal is subsequently received if from the image the person can be determined to have an age allowing purchase of the age-restricted item. A release signal is provided only if the authorization signal is received in order to allow payment of the age-restricted item.

### CROSS-REFERENCE TO RELATED APPLICATIONS

This application is a continuation-in-part and claims priority under 35 U.S.C. 120 of U.S. patent application Ser. No. 12/046,031, filed Mar. 11, 2008; and this application is a continuation and claims priority of International Application PCT/NL2008/050858, filed Dec. 30, 2008, and to be published in English, both of which are herein incorporated by reference in their entirety.

### BACKGROUND

The discussion below is merely provided for general background information and is not intended to be used as an aid in determining the scope of the claimed subject matter.

Aspects of the invention relate to a cash register system and method of operating a cash register system. In particular, the aspects of the invention relate to age verification in relation to the purchase of age-restricted items at such a cash register system.

Nowadays, items as tobacco and alcoholic beverages receive increased attention as to their free availability for the under-aged. Instances of selling age-restricted goods to underage individuals often result from careless employee verifications of a consumer's age before the consumer purchases age-restricted goods. Commonly, employees who are supposed to be verifying a consumer's age will not even ask for the consumer's identification, and in systems that prompt employees to enter the consumer's birth date, employees often enter a fictitious birth date. Such careless age verification may go unnoticed by a store manager or owner.

On the other hand, government authorities are increasingly willing to enforce fines and license suspension penalties on establishments that sell age-restricted goods to underage individuals. If authorities catch an employee selling age-restricted products to underage consumers, the manager or owner is often held responsible for the employee's actions and may even have their license to sell age-restricted goods revoked as a result of their employee's careless behaviour.

US 2002/087413 describes a vending machine including a video camera for transmitting an image of a buyer to a remotely located human operator, a document reader for transmitting an image of identification document(s) to the remotely located human in control of the vending machine, and a user interface which gives the appearance that the machine is autonomous even though the operator's approval is required prior to vending an age-restricted item. The machine also includes a payment acceptor and a dispensing apparatus.

Improvements are continually needed in the art to provide a cash register system, i.e. a payment system, for payment of age-restricted items.

### SUMMARY

This Summary and Abstract are provided to introduce some concepts in a simplified form that are further described below in the Detailed Description. This Summary and Abstract are not intended to identify key features or essential features of the claimed subject matter, nor are they intended to be used as an aid in determining the scope of the claimed subject matter. In addition, the description herein provided and the claimed subject matter should not be interpreted as being directed to addressing any of the short-comings discussed in the Background.

An aspect of the invention is a cash register system comprising an age verification system configured for verifying the age of a person for purchasing an age-restricted item. The age verification system comprises an image capture device such as but not limited to a video camera configured for capturing an image of the person. Also, a connecting device (e.g. network card, transmitter, transceiver) is provided for connecting to a remote age verification center and configured to transmit the image of said person to this age verification center. The connecting device may also receive an authorization signal from the age verification center if, from the image, the person can be determined to have an age allowing purchase of the age-restricted item. Also, a controller is provided that is configured for providing a release signal, e.g. to a cash register device, only in response to receiving the authorization signal in order to allow payment of the age-restricted item.

Furthermore, another aspect of the invention is a computer-implemented method of operating a cash register system for payment of an age-restricted item by a person. The cash register system comprises an age verification system. An image of a person is captured and transmitted to a remote age verification center. An authorization signal is subsequently received if, from the image, the person can be determined to have an age allowing purchase of the age-restricted item. A release signal is provided, e.g. to a cash register device, only if the authorization signal is received in order to allow payment of the age-restricted item.

The person image can be captured quickly and only requires the person under consideration to expose him- or herself to the video camera, i.e. the burden is very low. In the majority of cases, it can be verified from the person's image whether the age of the person is such that purchase of the age-restricted item is allowed. The cash register device is only released for payment of this item, if the authorization signal is received from the remote age verification center, i.e. the burden is also low for the cashiers since they have no involvement in the age verification process and are not in control of releasing the cash register device. Finally, the burden is also low for shop owners, since the age-restricted items do not need to be contained in a vending machine but can be made available in a traditional off-shelf manner in the shop. Moreover, the age-restricted items can be bought using self-service cash registers without requiring involvement of employees while still providing an appropriate check as to the age of the person buying the item. Consequently, as aspects of the invention, a system and method are provided that enable quick age verification in combination with appropriate but secure selling of age-restricted items.

It should be appreciated that, in some cases, the authorization signal and the release signal coincide, i.e. the (positive) authorization signal is sufficient to allow payment of the age-restricted item.

The age verification may comprise two separate process phases.

In a first phase, an image is captured of the person by an image capture device, e.g. a video camera. This image is sent to an age verification center within a very short time interval, possibly seconds. This process phase involves only a low burden and is convenient for the person involved. He or she only has to expose him/herself to the video camera. If it can be determined that the age of the person is appropriate for purchasing the age-restricted item(s), the authorization signal is received and the cash register device is released to allow payment for the age-restricted item.

Only if the age cannot be determined accurately by using the video camera, a second process phase may be required. This second phase involves the reading of an identification document of the person whose age could not be verified in the first phase. The image of the identification document, obtained from the same or another image capture device, should preferably comprise a picture of the legitimate holder of the document. This process phase is typically more time-consuming, and thus less convenient, than the first process phase. However, this phase can often be omitted, since the video image often allows determination whether or not a person should be allowed to purchase the item. The image of the identification document, or a sample thereof, is sent to the age verification center. Moreover, the person's image is obtained again, either from a database (or other means of storage) or from a second image by the image capture device in order to verify if the person image and document image are associated with the same person. If this is true and it can be determined that age of the person in question is appropriate for purchasing the age-restricted item, the authorization signal is received and the cash register device is released to allow payment for the age-restricted item in accordance with the embodiments of claims 2 an 13.

The embodiments of claims 3 and 14 enable the person's image and the document image to be captured and transmitted both to the age verification center at once in the beginning of the age verification process. This is particularly efficient for persons in between the age of 16-30 that have a reasonable chance of being required to present an identification document before an authorization signal is given.

The initiation of the age verification process can be triggered in a variety of ways.

In the embodiments of claims 5 and 15, the age verification process is triggered only if an age-restricted item is recognized. These embodiments have the advantage that communication with the age verification center only occurs when it is determined that age-verification is required. As an example, the age verification process is triggered by scanning a bar code of the age-restricted item or by user input of e.g. a cashier or the person under consideration. These embodiments provide the advantage that in particular the person image is only captured when required.

In the embodiments of claims 6, 7, 16 and 17, the age verification process can already be triggered before an age-restricted item is recognized. This is advantageous since, especially in large shops, such as supermarkets, it is of critical importance that delays are minimized. The embodiments enable age verification as soon as a signal from the cash register device for releasing the age verification system and an approval signal of the customer approving age verification are detected. The signal from the cash register device may be initiated e.g. by scanning of a (first) item (not necessarily an age-restricted item) at the cash register device or by a manually initiated signal (triggered e.g. by a cashier operating a device indicating that the “next customer” will be served).

The embodiments of claims 8 and 18 enable the age verification center to control use of the age verification system by only enabling the age verification system (in particular by enabling user input to approve capturing of the person image) during operation of the cash register device.

Often, age-restricted items are classified as to the age that is required to purchase the item. For example, certain items may require an age of 16, while others require an age of 18. The embodiments of claims 9 and 19 allow the age verification center to provide age classification information and, therefore, make sure that a single age verification is sufficient for a plurality of items having different age-restrictions. The age-classification information relates to the maximum age class for which the person is allowed to purchase items. For example, the age verification center may, after having received the person image and, possibly, the document image, provide an authentication signal indicating that the person under verification qualifies for the class age-16 items. If this person tries to purchase age-16 and age-18 items, the single authentication signal is sufficient to allow payment of the age-16 item, while payment is not allowed for the age-18 items.

The embodiments of claims 10, 11, 20 and 21 enable the cashier to collect the not-allowed items at an early stage.

A system comprising a cash register system and an age verification center is also disclosed.

It should be appreciated that the video camera and the document reader may be a single device, possibly with different settings adapted to the image to be made. The document reader may also be a scanner or a similar device.

It should also be appreciated that the image of the identification document may preferably contain an image of the legitimate holder of the identification document. The image of the identification document may comprise a complete image of (one or more pages of) the identification document, a part of the identification document and/or information derived from the identification document.

The system and method may also be used for controlling systems other than a cash register system, in particular systems for which age verification is desired. Examples of such other systems include a gambling machine or an entrance to an entertainment center, such as but not limited to a bar, a casino, or a nightclub. In these systems, the outcome of the age verification process determines whether the person under consideration may play on the gambling machine or may enter the entertainment center.

### BRIEF DESCRIPTION OF THE DRAWINGS

In the drawings:

FIG. 1 provides a schematic illustration of a system in accordance with an embodiment of the invention;

FIG. 2 provides a schematic illustration of a cash register system in accordance with an embodiment of the invention;

FIG. 3 provides a flow chart of a method of operating the cash register system of FIG. 2 in accordance with an embodiment of the invention; and

FIGS. 4A and 4B provide a schematic illustration of a system and a timing diagram of operating the system in accordance with an embodiment of the invention.

### DETAILED DESCRIPTION OF THE ILLUSTRATIVE EMBODIMENT

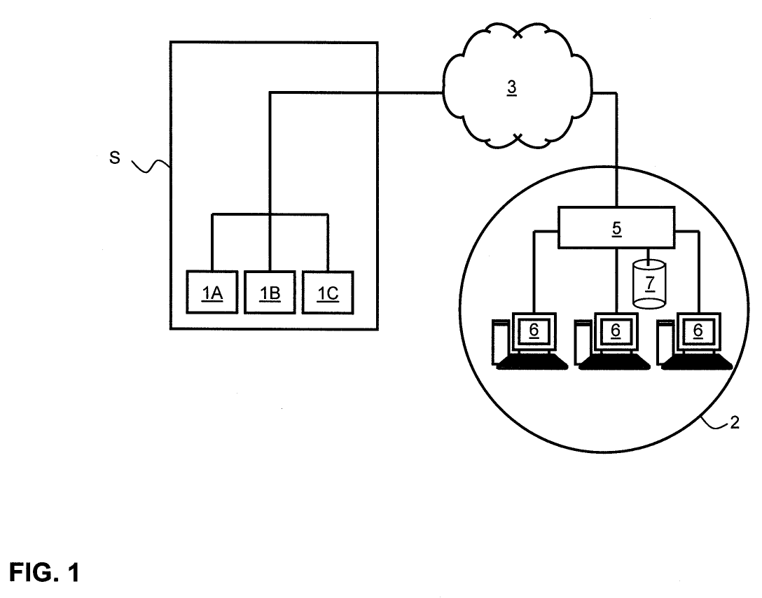

FIG. 1 shows a schematic illustration of a system comprising cash register systems 1A, 1B, 1C and an age verification center 2, hereinafter also referred to as verification center. The cash register systems 1A, 1B, 1C may comprise cash desk devices operated by a cashier or self-service cash desk devices. The cash register systems 1A, 1B, 1C are connected to the remote age verification center 2 via a network 3. The network 3 may comprise a wired network and/or a wireless, local and/or wide area (e.g. Internet) network.

The cash register systems 1A-1C are located in a shop S, e.g. a supermarket. Shop S sells a plurality of goods (items), amongst which are age-restricted items, such as tobacco, alcoholic beverages, adult magazines, weapons etc. The cash desk systems 1A-1C are for payment of items of the shop S.

The verification center 2 comprises a controller 5 and one or more display units 6. The display units 6 are configured to display images received from the cash register systems 1A-1C to human beings in order to verify the age of potential purchasers of age-restricted items. The images include a person image of a potential purchaser and/or an image of (and/or a part of) an identification document.

Controller 5 distributes the received images amongst the display units 6. The controller 5 may execute a round robin distribution process for efficient distribution of the images. In case more images are received than can be handled by the display units 6, the controller 5 is configured to manage a waiting cue of images. The controller 5 is also configured for providing, in the first verification phase, a person image of a potential purchaser to a first display unit 6 and, for the subsequent second verification phase, the person image and the document image on a second display unit 6, different from the first display unit.

The verification center 2 also comprises a database 7. The database 7 may store the received images and other data received from the cash register systems 1A-1C for future use. The images can be retrieved from the database 7 when desired. Information from the database can be used for sales transaction information for shop owners and allows authorities to check the transactions regarding age-restricted items. Furthermore, the database information may be used for statistical analysis.

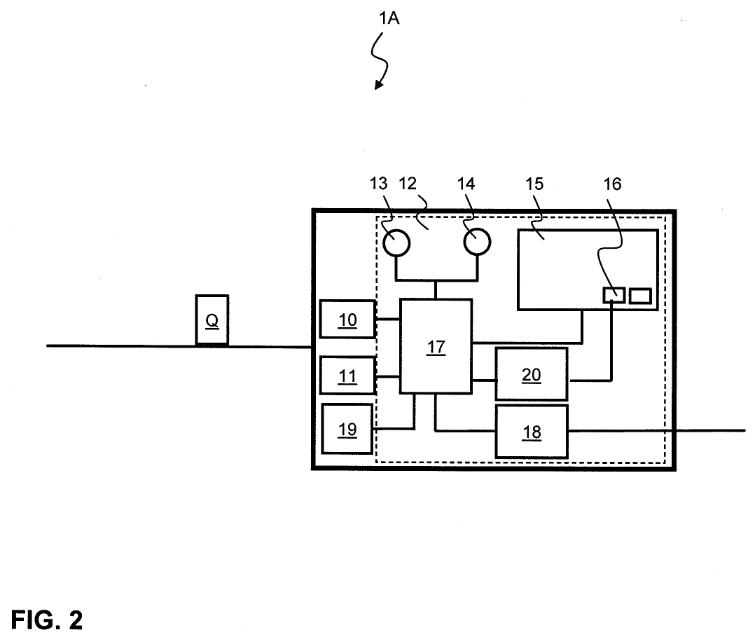

FIG. 2 provides a schematic illustration of a cash register system 1A as shown in FIG. 1. The self-service cash register system 1A can comprise a bar code reader 10, or other input device, an age verification button 11 and an age verification system 12.

The age verification system 12 of the cash register system 1A comprises an image capture device, for example, a video camera 13 for capturing a live image of a person in front of the camera (a person image) and a document reader 14 (which also comprises an image capture device, for example, a video camera in the present embodiment) configured for reading an identification document (a document image) of that person. Identification documents include, but are not limited to, passports, identity cards, drivers licenses etc. Preferably, the identification documents comprise a picture of the owner of the identification document in combination with information of the age of the owner. However, the documents may alternatively comprise information from which the age of the owner can be derived, e.g. at the age verification center 2. The age of the owner may e.g. be derived from information already stored in the database 7 or by making a connection to an external system from which the age of the owner of the identification document can be derived using the information of the document.

The age verification system 12 further comprises a display 15. The display 15 can be used to inform potential purchasers that their image, and/or an image of an identification document may be required before an item can be purchased. This information may be mandatory to comply with privacy provisions in some areas. Furthermore, the display 15 may guide potential purchasers through the age verification process. The display 15 may be a touch screen comprising (soft) keys 16 for entering instructions to the age verification system 12. The keys 16 may also be buttons with dedicated functions.

It should be appreciated that the image capture devices, in this example the video camera 13 and the document reader 14 are not necessarily integral parts of the age verification system 12.

The age verification system 12 comprises a controller 17 for issuing a release signal for the cash register system 1A. To that end, the controller 17 uses one or more of the following functional modules of the age verification system 12. It should be appreciated that the functions of the modules may be largely implemented as software code portions of one or more computer programs executed by the controller 17, which may be an ordinary computer processor in combination with one or more storage devices (e.g. hard disc) in a manner known as such to the skilled person.

It should be appreciated however, that the controller 17 may also be configured for receiving instructions and commands from the verification center 2, in particular the controller 5. As an example, controller 5 of verification center 2 may issue a release signal to release the cash register system 1A in order to allow payment for the age-restricted item, i.e. the authorization signal and the release signal coincide.

The age verification system 12 comprises a connection module or device 18 configured for connecting to the remote age verification center 2 to transmit the person image and/or the document image to the verification center 2. The connection module 18 may also receive commands/signals from the verification center 2, in particular an authorization signal and an identification request signal. The authorization signal may include the release signal to release the cash register system 1A to allow payment for the age-restricted item.

The controller 17 is configured for transmitting a release signal to a processor 19 of the cash register system 1A in order to release the cash register system 1A and to allow payment for the product Q, or in other words completion of sale.

In order to avoid undesired capturing of person images by video camera 13, the cash register system 1A comprises a approval module 20, that may be operated using age verification button 11 and/or keys 16, configured for instructing the video camera 13 to capture the person image.

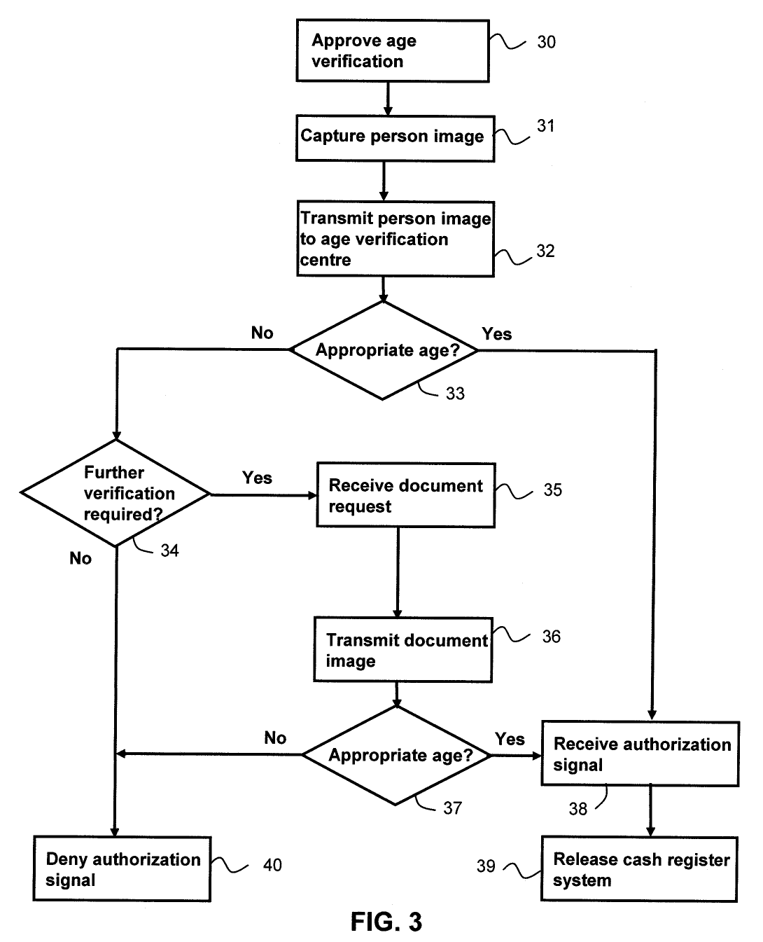

An embodiment of the operation of the system of FIG. 1 and the cash register system 1A of FIG. 2 will now be described with reference to FIG. 3. It will be assumed that a person, aged 22, enters, or desires access, to shop S and desires to perform an age-restricted task, in this example, purchase an age-restricted item Q. The age restriction for this item Q is 21. The person intends to purchase the age-restricted item (possibly in combination with other, non age-restricted, items). The person knowingly or unknowingly indicates an age-restricted task is desired, in this case, by scanning the age-restricted item using the bar code reader 10 of the cash register system 1A. Alternatively, the person may operate button 11 in order to approve and start the age verification process via approval module 20. The bar code reader 10 or other input device such as a keyboard to enter the item identifier, or the button 11 may command the controller 17 to initiate the age verification procedure.

It should be noted that, when cash register system 1A would not be a self-service system, another alternative includes a cashier scanning the bar code of the age-restricted item using bar code reader 10, using another input device such as a keyboard to enter the item identifier or employing the button 11. In that case, the person to be verified may approve the age-verification using keys 16 and approval module 20.

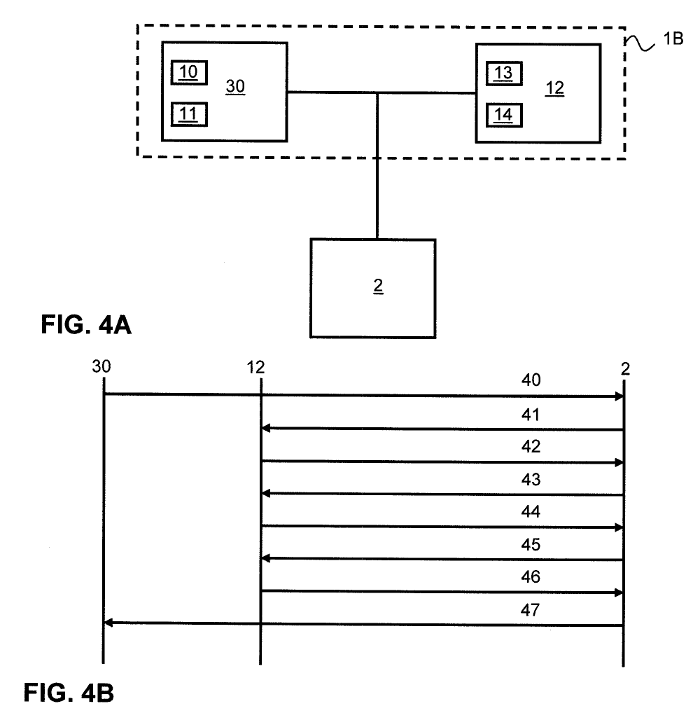

After identifying the item Q, the display 15 may inform the person of the required age verification procedure. As mentioned, the person may then, in step 30, first operate the button 11 for approval and to trigger the age verification process by activating the video camera 13. It should be noted that the age verification process may be triggered differently, as will be explained in further detail for a cashier-operated system with reference to FIGS. 4A and 4B.

The video camera 11 captures a live image of the person in step 31 and transmits the person image to the remote age verification center 2, using connection module 18 (step 32).

The controller 5 distributes the received person image to one of the available display units 6. A human operator estimates from the person image on the display 6 whether the purchaser has the required age for purchase of the selected item (step 33). If the human operator is in doubt, and believes that a further verification phase of the age is required, additional verification is provided at step 34. To that end, an identification request signal for an identification document is transmitted from the verification center 2 and received at the cash register system 1A (step 35).

The display 15, or cashier, instructs the person to provide an identification document. The document reader 14 is then activated. The person exposes an identification document to the document reader 14. An image of the identification document is transmitted from the age verification system 12 to the verification center 2 in step 36. Moreover, video camera 13 captures another image of the person and also transmits this person image to the verification center 2 in step 36. It should be noted, however, that alternatively, the person image obtained in step 32 is used again. In the latter case, the person image is e.g. retrieved from the database 7 using an entry key assigned in step 32.

The controller 5 of the verification center 2 provides the image of the document to an available display unit 6 (which is not necessarily the same display unit 6 used for the first age verification phase) in combination with the person image (also received in step 36 or obtained from database 7). The human operator is now able to conclude from the identification document image and the person image that the person is the legitimate holder of the identification document and that this person has reached the age of 22 and that, consequently, he is allowed to purchase the item (step 37). An authorization signal is then transmitted from the verification center 2 and is received at the age verification system 12 in step 38. Controller 17 may now release the cash register system 1A by instructing processor 19 to allow payment by the person for the product Q (step 39). As mentioned before, the authorization signal of the verification center 2 may also result in a direct release of the payment.

The first age verification phase of step 33 will generally be sufficient in a majority of cases. If the person would e.g. have the age of 50, the first age verification phase would already have resulted in receiving the authorization signal in step 38. On the other hand, if the person would clearly be under-aged, the first age verification phase (step 33) would not have resulted in obtaining an authorization signal and the cashier or person would not be able to pay for the item Q, i.e. the cash register system would remain locked for this item (step 40). The same would be true if the human operator would conclude that the age of the person was not sufficient in the second age verification phase (step 37).

It should be noted that the system allows the person image and the document image to be captured and transmitted to the age verification center already in step 31 and 32. This is particularly efficient for persons in between the age of 16-30 that have a reasonable chance of being required to present an identification document before an authorization signal is given.

FIGS. 4A and 4B provide a schematic illustration of a system 1B and a timing diagram of operating the cash register system 1B in accordance with an embodiment of the invention. In this example, system 1B is a cashier-operated system comprising a cash register device 30 and the age verification system 12.

Cash register system 1B is connected to remote age verification center 2 for performing the age verification process. It should be noted that the actual connection to cash register system 1B may be to the cash register device 30, to the age verification system 12 or to another module, e.g. an intermediate unit, connected to both the cash register device 30 and the age verification system 12.

FIG. 4B is an exemplary timing diagram for operating the cash register system 1B.

In the initial stage, video camera 13 and document reader 14 are disabled.

In step 40, a cash register signal is transmitted from the cash register device 30 to the age verification center 2. This cash register signal can be triggered by scanning a bar code of a first item of a customer, not necessarily an age-restricted item, by the cashier using a bar code reader 10. Alternatively, the cashier may have operated a button 11 or other input device.

In step 41, an enabling signal is received at the age verification system 2 of the cash register system 1B. Display 15 (see FIG. 2) of the age verification system 2 informs the customer that age verification is or may be required and solicits approval of the customer to perform this process. The customer may neglect this information if (s)he is under the assumption that such verification is not necessary, e.g. because (s)he does not intend to purchase age-restricted items. However, normally, the customer would approve the age verification process to be conducted by user input, step 42, using keys 16 (see FIG. 2).

In step 43, an information signal is received from the age verification center 2 for activation of the image capture device, herein by example, video camera 13.

It should be noted that the cash register signal of step 40 may also be transmitted directly to the age verification system 12, followed by approval of the customer (user input) to trigger the age verification process, i.e. without involving the age verification center 2 in the prior triggering phase.

Steps 44-46, relating to the person image transmission, the possible identification request signal if the age cannot be verified from the person image and the document image transmission, respectively, involve the actual age verification process as previously described.

Step 47 indicates the authorization signal or authorization denial signal determining whether or not purchase of an item is allowed.

Further information, e.g. information of an age-restricted item triggered by scanning such an item, may also be communicated from the cash register system 1A or 1B to the age verification center 2.

It should be noted that steps 40-47 (possibly excluding steps 45 and 46 if not required) can be conducted at any time after the customer has given approval and prior to payment of the items. Therefore, delays resulting from age verification at the cash register system 1B can be minimized.

Often, age-restricted items Q are classified as to the age that is required to purchase the item. For example, certain items may require an age of 16, while others require an age of 18. The authorization signal in step 47 may therefore comprise age classification information to enable that a single age verification is sufficient for a plurality of items having different age-restrictions. The age-classification information relates to the maximum age class for which the person is allowed to purchase items. For example, the age verification center 2 may, after having received the person image in step 44 and, possibly, the document image in step 46, provide an authentication signal indicating that the person under verification qualifies at maximum for the class age-16 items. If this person tries to purchase age-16 and age-18 items, the single authentication signal in step 47 is sufficient to allow payment of the age-16 item, while payment is not allowed for the age-18 items.

Of course, the same applies for a self-service cash register system 1A, as depicted and described with reference to FIGS. 2 and 3.

If, in step 47, an authorization denial signal is received, this signal may immediately block further operation of the cash register device 30, thereby allowing the cashier to pick out the items that should not be purchased by the person for which the age-verification process had been conducted.

Although the subject matter has been described in language specific to structural features and/or methodological acts, it is to be understood that the subject matter defined in the appended claims is not necessarily limited to the specific features or acts described above as has been determined by the courts. Rather, the specific features and acts described above are disclosed as example forms of implementing the claims.

1. A cash register system comprising an age verification system configured for verifying the age of a person for purchasing an age-restricted item, the age verification system comprising:
a video camera configured for capturing an image of said person;
a connecting device configured for connecting to a remote age verification center and configured to transmit said image of said person to said age verification center and to receive an authorization signal from said age verification center if from said image said person can be determined to have an age allowing purchase of said age-restricted item; and
a controller configured for providing a release signal only in response to receiving said authorization signal to allow payment of said age-restricted item.

2. The cash register system according to claim 1, wherein said age verification system further comprises a document reader configured for capturing an image of an identification document of said person, and wherein said age verification system is further configured for:
receiving an identification request signal if said age of said person can not be determined from said image of said person, said identification request signal representing a request for providing an identification document to said document reader;
transmitting said image of said identification document to said remote age verification center, and
receiving said authorization signal from said age verification center if from said image of said identification document said person can be determined to have an age allowing purchase of said age-restricted item.

3. The cash register system according to claim 1, wherein said age verification system further comprises a document reader configured for capturing an image of an identification document of said person, and wherein said connecting means are configured for transmitting said images of said person and said identification document to said age verification center and to receive an authorization signal from said age verification center if from said image of said document said person can be determined to have an age allowing purchase of said age-restricted item.

4. The cash register system according to claim 2, wherein said document reader comprises a further video camera.

5. The cash register system according to claim 1, and further comprising a controller configured for triggering said age verification system to verify said age of said person in response to receiving item information, such as a bar code, of said age-restricted product.

6. The cash register system according to claim 1, and further comprising a controller configured for triggering said age verification system to verify said age of said person in response to a user input, said user input being at least one of a user input at a cash register device and a user input at said age verification system.

7. The cash register system according to claim 1, and further comprising a controller configured for triggering said age verification system to verify said age of said person in response to at least one of cash register signal from a cash register device following detection of an item and a user input at said age verification system.

8. The cash register system according to claim 6, wherein said cash register system is configured for:
transmitting said user input or said cash register signal from said cash register device, respectively, to said age verification center;
processing an enabling signal for enabling said user input at said age verification system from said age verification center.

9. The cash register system according to claim 1, wherein said authorization signal comprising age-classification information, wherein said cash register system is configured for processing said age-classification information to provide said release signal to allow payment of a plurality of age-restricted items.

10. The cash register system according to claim 1, and further comprising a cash register device, wherein said cash register system is configured for blocking said cash register device in response to receiving an authorization denial signal from said age verification center.

11. The cash register system according to claim 10, wherein said cash register system is configured for blocking said cash register device immediately after having received said authorization denial signal.

12. A computer-implemented method of operating a cash register system for payment of an age-restricted item by a person, said cash register system comprising an age verification system, the method comprising:
capturing an image of said person;
transmitting said image of said person to a remote age verification center;
receiving an authorization signal if from said image said person can be determined to have an age allowing purchase of said age-restricted item;
providing a release signal only in response to receiving said authorization signal in order to allow payment of said age-restricted item.

13. The method according to claim 12, and further comprising:
receiving an identification request signal from said remote age verification center if the age of said person can not be determined from said image of said person;
capturing an image of an identification document of said person in response to said identification request signal;
transmitting said image of said identification document to said remote age verification center;
receiving said authorization signal if the age of the person can be determined from said image of said identification document.

14. The method according to claim 12, and further comprising:
capturing an image of an identification document of said person;
transmitting said image of said person and said image of said identification document to said remote age verification center;
receiving said authorization signal if the age of the person can be determined from said identification document.

15. The method according to claim 12, and further comprising capturing at least one of said image of said person and said image of said document in response to receiving item information, such as a bar code, of said age-restricted item.

16. The method according to claim 12, and further comprising capturing at least one of said image of said person and said image of said document in response to receiving a user input, said user input being at least one of a user input at a cash register device and a user input at said age verification system.

17. The method according to claim 12, and further comprising capturing at least one of said image of said person and said image of said document in response to at least one of cash register signal from a cash register device following detection of an item and a user input at said age verification system.

18. The method according to claim 16, and further comprising:
transmitting said user input or said cash register signal from said cash register device, respectively, to said age verification center;
processing an enabling signal for enabling said user input at said age verification system from said age verification center.

19. The method according to claim 12, wherein said authorization signal comprising age-classification information, the method further comprising processing said age-classification information to provide said release signal to allow payment of a plurality of age-restricted items.

20. The method according to claim 12, and further comprising blocking a cash register device of said cash register system in response to receiving an authorization denial signal from said age verification center.

21. The method according to claim 20, and further comprising blocking said cash register device immediately after receiving said authorization denial signal.

22. The method according to claim 12, and further comprising capturing at least one of said image of said person and said image of said document with a video camera.

23. An age verification system configured for verifying the age of a person for completion of a task, the age verification system comprising”
an image capture device configured for capturing an image of said person;
a connecting device configured for connecting to a remote age verification center and configured to transmit said image of said person to said age verification center and to receive an authorization signal from said age verification center if from said image, said person can be determined to have an age allowing completion of the task; and
a controller configured for providing a signal indicating that said person can complete the task based on the authorization signal.
